(19) United States
(12) Patent Application Publication
(10) Pub. No.: US 2008/0240138 A1
(43) Pub. Date: Oct. 2, 2008

(54) Tree type broadcast system, connection target determination method, connection management device, connection management process program, and the like

(75) Inventor: Tadashi Hirano, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/073,351

(22) Filed: Mar. 4, 2008

(30) Foreign Application Priority Data
Mar. 27, 2007 (JP) 2007-80628

(51) Int. Cl. H04L 12/28

(52) U.S. Cl. 370/408

(57) ABSTRACT

A connection management device for managing connection mode between node devices in a tree type broadcast system formed by participation of all or a part of a plurality of node devices included in a distributed content storing system where a plurality of content data are distributed and stored in the plurality of node devices and each of the plurality of node devices provides content data stored in the own node through a network in response to a request from the other node devices, to thereby sequentially transfer the content data broadcasted by the broadcasting device from the node devices on upper hierarchies to the node devices on lower hierarchies, the connection management device including:
a memorizing device;
a participation request information receiving device;
a connection target determining device; and
a node information transmission device.

The entire disclosures of Japanese Patent Application No. 2007-080628 filed on Mar. 27, 2007 including the specification, claims, drawings and summary are incorporated herein by reference in its entirety.

### BACKGROUND OF THE INVENTION

1. Field of the Invention

The present invention relates to a technical field of a peer to peer (P2P) type communication system including a plurality of node devices which can mutually communicate through a network.

2. Discussion of the Related Art

As this kind of peer to peer communication system, a distributed content storing system where content data are distributed and located (distribution storing) into a plurality of node devices is already known. By using this system, fault tolerance and property of distributing access is enhanced. Location of content data thus distributed and stored is enabled to be efficiently searched for by use of, for example, a distributed hash table (hereinafter, referred to as DHT) disclosed in U.S. Unexamined Patent Publication No. US 2007/283043 A1 (or Japanese Unexamined Patent Publication No. 2006-197400). The DHT is stored by each node device and node information indicating a plurality of node devices to be a transfer destination (e.g. including IP addresses and port numbers) is registered in the DHT.

Then, a node device participating in the distributed content storing system transmits a message (query) for searching for (finding) location of the content data when the node device wants to acquire desired content data. Then, the message is transferred to a node device managing the location of the content data by a plurality of relay node devices according to the DHT and finally, node information is acquired from the node device managing the location which is the final destination of the message. Thus, the node device which transmitted the message requests the content data to the node device storing the content data regarding the search and receives the content data.

Meanwhile, as disclosed in U.S. Unexamined Patent Publication No. US 2007/133587A1 (or Japanese Unexamined Patent Publication No. 2006-33514), there is conventionally known a tree type broadcast (delivery) system where each node device has topology information for recognizing network connection relation, each node device is connected to a higher hierarchy (upper stream) node device recognized by the topology information, receives stream data transmitted from the higher hierarchy node device, and transfers (relays) the stream data thus received to a lower hierarchy (lower stream) node device. By this system, each node device participating in the tree type broadcast system can receive streamed content data and reproduce it.

### SUMMARY OF THE INVENTION

Meanwhile, a case where a node device participates in both the above-mentioned distributed content storing system and a tree type broadcast system is conceivable. However, in such a case, in a case where process that one node device receives and transfers (provides) content data transmitted from a higher hierarchy node device to a lower hierarchy node device in a tree type broadcast system while reproducing the content data and process to provide the content data in response to a request for the content data from another node device in a distributed content storing system are simultaneously carried out, process load of the node device and load of a line to which the node device is connected are increased and there is a possibility that reproduction of content being viewed becomes difficult or topology of a delivery (broadcast) tree is broken due to insufficient transfer to a lower hierarchy node device.

The present invention is made in consideration of the above problem, and the object of the present invention is to provide a tree type broadcast system, a connection target determination method, a connection management device, a connection management process program, and the like which can suppress increase of process load of the node device and load of a line to which the node device is connected and carry out stable provision of content data even in a case where the node device participates in both a distributed content storing system and a tree type broadcast system.

According to an aspect of the present invention, there is provided a connection management device for managing connection mode between node devices in a tree type broadcast system formed by participation of all or a part of a plurality of node devices included in a distributed content storing system where a plurality of content data are distributed and stored in the plurality of node devices and each of the plurality of node devices provides content data stored in the own node through a network in response to a request from the other node devices, the tree type broadcast system being connected in a tree-like shape through a communication means while having a broadcasting device at its top and forming a plurality of hierarchies of the node devices through the communication means, to thereby sequentially transfer the content data broadcasted by the broadcasting device from the node devices on upper hierarchies to the node devices on lower hierarchies, the connection management device including:

a memorizing means for memorizing content provision existence information indicative of whether or not the node device, participating in the tree type broadcast system, is providing content data, stored by the own node, to another node device in the distributed content storing system;

a participation request information receiving means for receiving participation request information transmitted from the node device, newly participating in the tree type broadcast system, which requests node information indicative of the node device to be a connection target, to which the node device is to be connected;

a connection target determining means for determining the node device to be the connection target for the node device transmitting the participation request information, the connection target determining means determining by priority the node device which is not in a state of providing the content data to the other node devices in reference of the content provision existence information; and

a node information transmission means for transmitting node information indicative of the node device to be the connection target thus determined to the node device transmitting the participation request information.

According to the present invention, the connection management device memorizes the content provision existence information indicative of whether or not the node device participating in the tree-type broadcasting system is now providing content data stored in the own node device in the distributed content storing system. When the participation request information transmitted from the node device newly participating in the tree-type broadcasting system is received, the content provision existence information is referred to, the node device which is not now providing the content data to the other node devices is determined with priority as a connection target of the node device transmitting the participation request information, and the node information indicative of the node device to be the connection target is transmitted to the node device transmitting the participation request information. Because the system is thus constructed, even when the node device participates in both of the distributed content storing system and the tree-type broadcasting system, it is possible to suppress processing load in the node device and increment of load in a line to which the node device is connected, whereby it is possible to stably provide the content data.

According to the present invention, a connection management device stores content provision information indicating whether or not the node device participating in a tree type broadcast system is providing content data stored by the own node to another node device in the distributed content storing system, refers to the content provision information when participation request information transmitted from the node device to be newly participated in the tree type broadcast system is received, determines with priority a node device which is not providing content data to another node device in the distributed content storing system as a connection target of the node device which transmitted the participation request information, and transmits node information indicating a node device thus determined as the connection target to the node device which transmitted the participation request information. Therefore, even in a case where a node device participates in both the distributed content storing system and the tree type broadcast system, increase of process load of the node device and load of a line to which the node device is connected is suppressed and content data can be stably provided.

### BRIEF DESCRIPTION OF THE DRAWINGS

FIG. 1 is a view showing an example of connection mode of each node device in a communication system related to the present embodiment.

FIG. 2 is a conceptual view of a communication system S related to the present embodiment.

FIG. 3 is a view showing an example of a routing table using DHT retained by a node N2.

FIG. 4 is a conceptual view showing an example of an ID space of DHT.

FIG. 5 is a conceptual view showing an example of flow of a content location inquiry (search) message transmitted from a user node in an ID space of DHT.

FIG. 6 is a view showing a schematic configuration of a connection management server 10.

FIG. 7 is a conceptual view showing a connection target of a new participant node.

FIG. 8 is a conceptual view showing how connection is changed in a case where there is a connection target change request.

FIG. 9 is a view showing schematic configuration of a node Nn.

FIG. 10 is a flowchart showing process of a control unit 11 of a node Nn.

FIG. 11 is a flowchart showing process of the control unit 11 of a node Nn.

FIG. 12 is a flowchart showing process of the control unit 11 of a node Nn.

FIG. 13 is a flowchart showing process of a control unit 101 of the connection management server 10.

FIG. 14 is a flowchart showing process of the control unit 101 of the connection management server 10.

### DETAILED DESCRIPTION OF PREFERRED EMBODIMENTS

Hereinafter, a best embodiment of the present invention will be described in reference of figures. Here, the embodiment explained below is an embodiment in a case where the present invention is applied to a communication system.

Hereinafter, each designation of numerical reference in the drawings is typically as follows:
8: Network;
9: Overlay network;
10: Connection management server;
11: Control unit;
12: Memory unit;
13: Buffer memory;
14: Decoder;
15: Image processing unit;
16: Display unit;
17: Audio processing unit;
18: Speaker;
20: Communication unit;
21: Input unit;
22: Bus;
101: Control unit;
102: Memory unit;
103: Communication system;
104: Bus;
Nn: Node;
S: Communication system;
SX1: Distributed content storing system; and
SX2: Tree type broadcast system

### [1. Configuration and the Like of a Communication System]

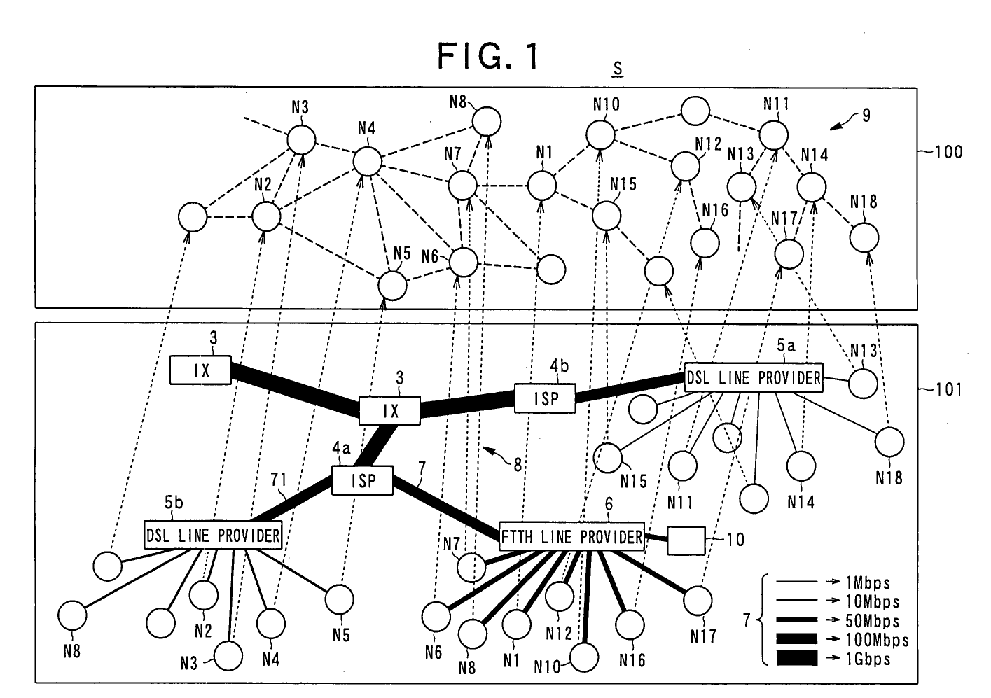

First, with reference to FIG. 1 and so on, schematic configuration and the like of a communication system according to the present embodiment will be explained.

FIG. 1 is a diagram showing an example of connection mode of each node device in a communication system according to the present embodiment.

As shown in the lower rectangular frame 101 in FIG. 1, a network 8 (communication network in real world and an example of a communication means) of the Internet or the like is constructed by an internet exchange (IX) 3, internet service providers (ISP) 4a and 4b, digital subscriber line providers (or device thereof) (DSL) 5a and 5b, fiber to home line provider ('s device) 6, and communication line (for example, such as a telephone line or an optical cable) 7 and the like. Here, in the network (a communication network) 8 of the example of FIG. 1, a router for transferring data (packet) is appropriately inserted.

In such a network 8, a plurality of node devices (hereinafter referred to as a “node”) Nn (n=any one of 1, 2, 3, . . . ) are connected. Moreover, a unique manufacturing number and an internet protocol (IP) address are assigned to each of the nodes Nn. Such manufacturing numbers and IP addresses do not overlap among a plurality of nodes.

Then, a communication system S according to the present embodiment is a peer to peer network system formed by participation of any plurality of nodes Nn of these nodes Nn, as shown in the upper rectangular frame 100 of FIG. 1. Here, a network 9 shown in the upper rectangular 100 of FIG. 1 is an overlay network 9 (a logical network) including a virtual link formed by use of an existing network 8.

Moreover, the communication system S is a complex system of a distributed content (type) storing system and a tree type broadcast system (also called a tree type content delivery system).

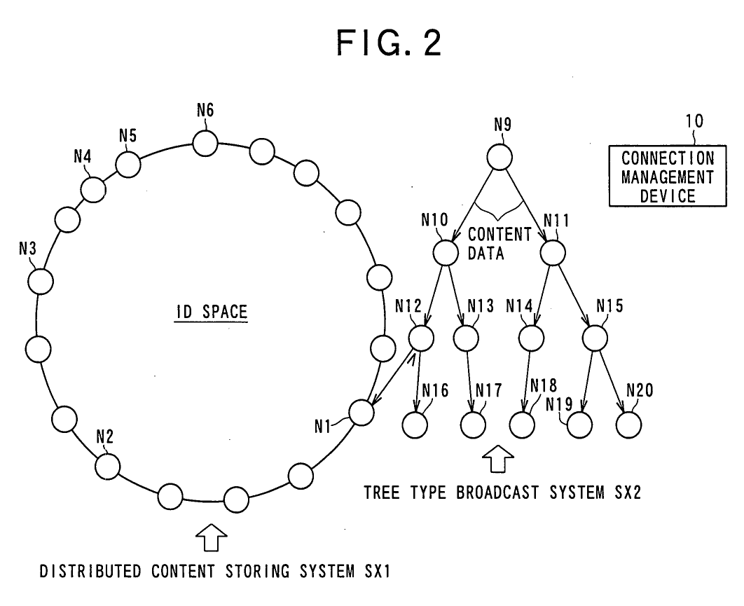

FIG. 2 is a conceptual view of the communication system S according to the present embodiment.

In FIG. 2, a plurality of content data (actually, copied data (replicas) which are copies of content data) are distributed and stored in a plurality of nodes Nn participating in a distributed content storing system SX1 (a node to store content data is arbitrary and, for example, stored in nodes N1, N3, and N5) in the system SX1 and in response to a request from another node Nn (e.g. a node N2), content data stored by own node can be provided through the network 8.

Meanwhile, a tree type broadcast system SX2 includes all or part of the plurality of nodes Nn (participating) in the distributed content storing system SX1 (in the example of FIG. 2, node N1 of the nodes Nn in the distributed content storing system SX1 corresponds thereto), is formed by participation of a plurality of nodes Nn, wherein the plurality of nodes Nn are connected in a tree shape through the network 8 while forming a plurality of hierarchies with a node N9 a stop of the hierarchies, the node N9 being a broadcast device, and content data broadcast (streamed delivered) by the node N9 is sequentially transferred from a higher hierarchy node Nn (e.g. a node N10 or the like) to a lower hierarchy node Nn (e.g. a node N16 or the like).

### [1-1. Configuration, Function and the Like of Distributed Content Storing System SX1]

Next, detailed explanation of the distributed content storing system SX1 will be given.

The distributed content storing system SX1 is realized by a specific algorithm, for example, an algorithm using a distributed hash table (DHT).

Then, each of the node Nn participating in the distributed content storing system SX1 has a node ID as unique identification information. For example, the node ID is a hashed value obtained by hashing an IP address or manufacturing number (e.g. bit length is 160 bit), individually allocated to each of the nodes Nn, by a hash function (e.g. SHA-1) commonly used, whereby the nodes are distributed and located in one ID space without deviation, as shown in FIG. 2.

Participation into the distributed content storing system SX1 is done when a node Nn which has not participated yet (for example, anode N8) transmits a participation message indicative of a participation request to an arbitrary node Nn which has already participated in the system (e.g. a contact node which is always participating in the system SX1).

As described above, the node ID obtained by a hash function common used (hashed) has a very low possibility of having the same value if the IP address or the manufacturing number differs. It is required for the node ID to have a bit number enough to include maximum operation number of nodes. For example, when the number is a 128-bit number, the node can operate 2̂128=340×10̂36 nodes.

Moreover, each of nodes Nn retains a routing table using DHT. The routing table regulates transfer destination of various types of messages on the content distributed content storing system SX1. Specifically, a plurality of node information (transfer destination node information) including a node ID, an IP address, a port number, or the like of other nodes Nn which are appropriately apart in the ID space are registered.

One node Nn participating in the distributed content storing system SX1 registers node information of minimum and necessary nodes Nn of all the nodes Nn participating in the system SX1 in the routing table. With respect to a node Nn with its node information not known (not registered), various types of messages are transferred between each nodes Nn and delivered.

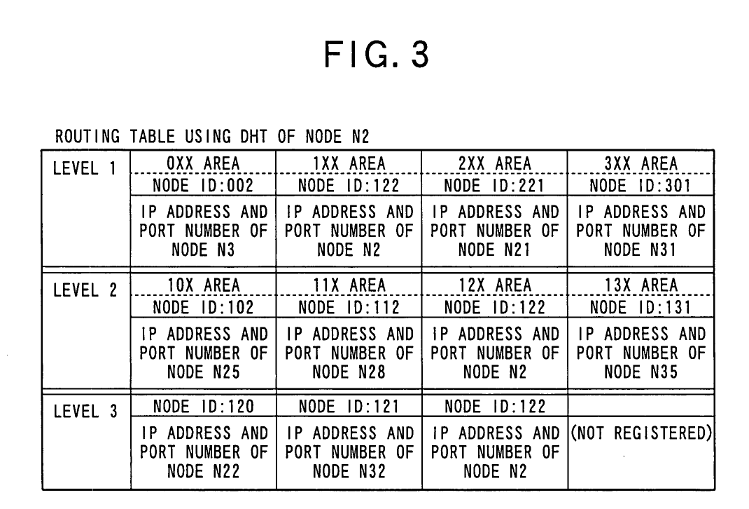

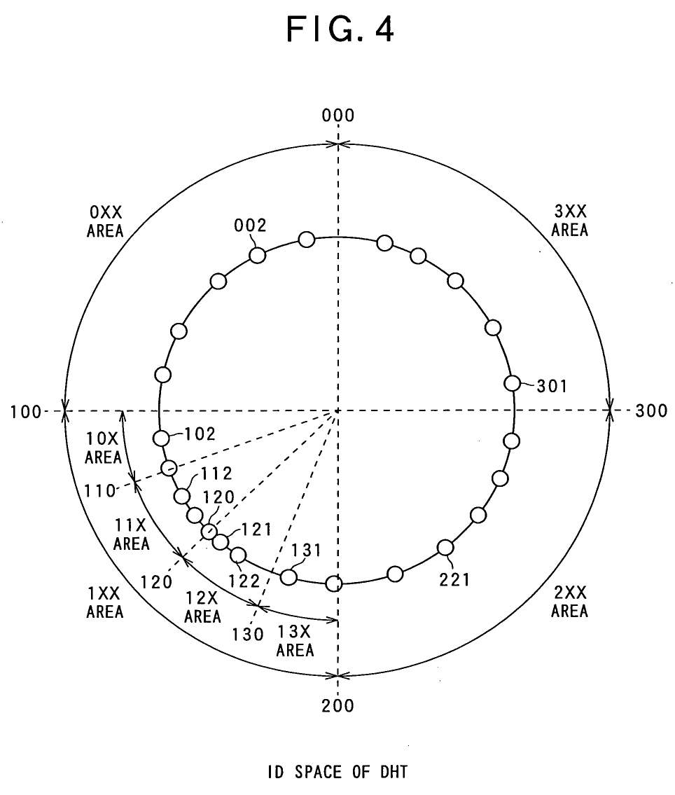

Here, with reference to FIGS. 3 and 4, a routing table using DHT will be explained.

FIG. 3 is a view showing an example of a routing table of the DHT retained by the node N2 and FIG. 4 is a conceptual diagram showing an example of an ID space of the DHT.

Here, in the examples of FIGS. 3 and 4, for easy of explanation, bit length of a node ID is set to be 2 bit×3 digits=6 bit, and each digit is expressed by quaternary number (an integer between 0 and 3) (practically, a longer bit length is used and each digit is divided into, for example, 4 bit and expressed by hexadecimal of 0 to f).

In the example of FIG. 3, the routing table of the DHT includes tables of levels 1 to 3 (classified into a plurality of levels). In a table entry of each level, node IDs and IP addresses and port numbers of a node Nn corresponding to the node IDs are associated and registered as node information. Each area of a table in each level is an area obtained by dividing a node ID space of the DHT. For example, as shown in FIG. 4, in level 1, an entire ID space of the DHT is divided into four parts and an area where node IDs “000” to “033” exist is designated as a 0XX area, an area where node IDs “100” to “133” exist is designated as a 1XX area, an area where node IDs “200” to “233” exist is designated as a 2XX area, and an area where node IDs “300” to “333” exist is designated as a 3XX area. Moreover, in level 2, areas in level 1 (that is, areas “0XX” to “3XX”) are further divided into four. For example, 1XX area is divided into four parts and an area where node IDs “100” to “103” exist is designated as a 10X area, an area where node IDs “110” to “113” exist is designated as a 11X area, an area where node IDs “120” to “123” exist is designated as a 12X area, and an area where node IDs “130” to “133” exist is designated as a 13X area.

Then, for example, provided that a node ID of a node N2 is “122”, as shown in FIG. 3, in a table entry of the node N2 in 1XX area (where the own node N2 exists) in level 1, anode ID, an IP address and the like of the own node N2 (because IP address belongs to the own node, registration of the IP address in the routing table is not required) are registered and in areas where the own node N2 does not exist (in other words, 0XX, 2XX, and 3XX areas), node IDs, IP addresses and the like of other arbitrary nodes Nn are registered.

Moreover, in the table of the node N2 in 12X area (an area where the own node N2 exists) in level 2, as shown in FIG. 3, node ID and IP address of the own node N2 (because IP address belongs to the own node N2, registration of the IP address in the routing table is not required) are registered and in areas where the own node does not exist (in other words, 10X, 1X, and 13X areas), node IDs and IP addresses of other arbitrary nodes Nn are registered.

Further, in level 3 of the node N2, node IDs which are between “120” and “122”, IP addresses, and the like (because IP address belongs to the own node N2, registration of the IP address in the routing table is not required) a reregistered, as shown in FIG. 3.

In the examples of FIGS. 3 and 4, since bit length of a node ID is set to be three digits×2 bit, a table having three levels can cover everything. However, when bit length of a node ID is increased, more table is required for the increased amount (for example, in a case where bit length of a node ID is set to be 16 digits×4 bit, a table for 16 levels is required).

As described above, in a routing table of DHT in the present embodiment, the higher the level becomes, the narrower the area becomes.

Such DHT is given when a non-participant node participates in the distributed content storing system SX1.

Meanwhile, various content data (e.g. movie, music, or the like) are distributed and saved (stored) in a plurality of nodes Nn in the distributed content storing system SX1 (in other words, replicas which are copies of content data are distributed and stored).

For example, content data of a movie having a title of XXX are stored in nodes N1 and N5, while content data of a movie having a title of YYY are stored in a node N3. In such a manner, content data are distributed in a plurality of nodes Nn (hereinafter referred to as a “content retention node” to be stored).

Moreover, to each of such content data, information such as a content name (title) and a content ID (identification information unique to each content) are added. The content ID is generated by, for example, hashing content name+arbitrary numerical value (or upper some bytes of the content data) by the hash function commonly used to obtain the node ID (allocated in the same ID space as the node ID). Alternatively, a system operator may give a unique ID value (same bit length as a node ID) to each content. In this case, content catalog information describing association between a content name and a content ID is distributed to all the nodes Nn.

Further, location of content data thus distributed and stored, that is, index information including a pair of node information (including, for example, an IP address, a port number, and the like) indicating a node Nn in which the content data is stored and content ID corresponding to the content data is stored (stored in index cache) and managed by a node Nn which manages location of the content data (i.e. a node Nn for managing node information of a node Nn which can transmit content data) (hereinafter referred to as a “root node” or a “root node of the content (content ID).”).

For example, index information of content data of the movie having a title of XXX is managed by a node N4 being a root node of the content (content ID) and index information of content data of a movie having a title of YYY is managed by a node N6 being a root node of the content (content ID). In other words, because root nodes are divided for each content, load is distributed. Moreover, even in a case where one same content data (having same content ID) are stored in a plurality of content retention nodes, index information of such content data can be managed by one root node.

Moreover, such a root node is set to be a node Nn having a node ID closest to, for example, a content ID (e.g. upper digits match the most).

Then, in a case where a user of a node Nn wants to acquire desired content data, the node Nn wanting to acquire the content data (hereinafter referred to as a “user node”) generates a content location inquiry (search) message (query) including a content ID of content data selected from, for example, content catalog information and the own node information and transmits the message to another node Nn according to a routing table using DHT of the own node. That is, the user node transmits a content location inquiry (search) message to a root node (destination of the message is the root node). Thus, the content location inquiry (search) message finally reaches the root node by DHT routing using a content ID as a key.

Here, the content catalog information is delivered to all the nodes Nn from, for example, a content management server and a content name, a content ID, and the like are described in the content catalog information.

Moreover, a content ID included in the content location inquiry (search) message may be generated by hashing a content name with the common hash function using the user node.

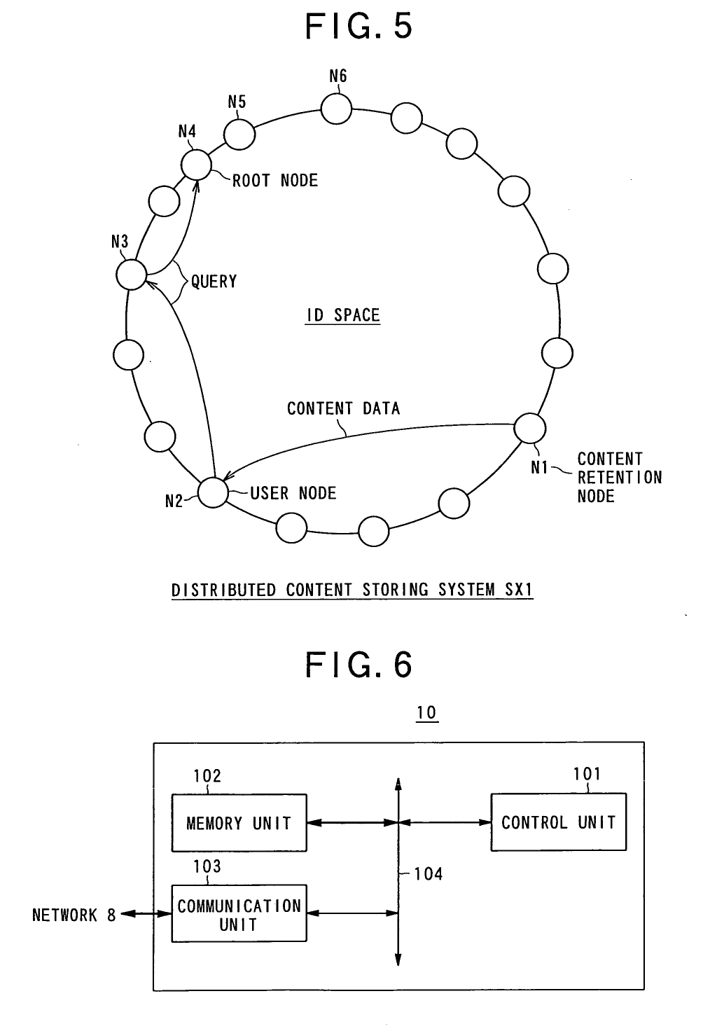

FIG. 5 is a conceptual view showing a flow of content location inquiry (search) message transmitted from a user node in an ID space of DHT.

In the example of FIG. 5, for example, a node N2 being a user node refers to a table of level 1 of own DHT, acquires an IP address and a port number included in node information of, for example, a node N3 having a node ID closest to a content ID included in the content location inquiry (search) message (e.g. upper digits match the most), and transmits the content location inquiry (search) message to the IP address and the port number.

Meanwhile, the node N3 receives the content location inquiry (search) message, refers to a table of level 2 of the own DHT, acquires an IP address and a port number included in node information of, for example, a node N4 having a node ID closest to a content ID included in the content location inquiry (search) message (e.g. upper digits match the most), and transfers the content location inquiry (search) message to the IP address and the port number.

Then, the node N4 receives the content location inquiry (search) message, refers to a table of level 3 of the own DHT, and recognizes that a node having a node ID closest (e.g. upper digits match the most) to the content ID included in the content location inquiry message is the node N4 itself. In other words, the node N4 recognizes that a root node of the content ID is the node N4 itself. Then, the node N4 acquires index information corresponding to the content ID included in the content location inquiry (search) message from an index cache and replies the index information to the user node which transmitted the content location inquiry (search) message. Thus, the user node can transmit a content transmission request message (request information indicating provision request of content data) to the content retention node, for example a node N1, storing desired content data and receive the content data.

Alternatively, the node N4 being a root node transmits a content transmission request message (request information including node information of a user node indicating provision request of content data to the user node) to a content retention node indicated by the node information included in the index information. Thus, the user node can receive a provision of the content data from, for example, the node N1 being the content retention node.

Here, the user node may acquire (receive) index information from a relay node (e.g. a cache node of the node N3) which caches the index information same as one of a root node before a content location inquiry message reaches the root node.

The user node which acquired and stored the content data in such a manner generates a publish (registration notification) message including a content ID of the content data, node information of the own node, and the like (since the content data is stored, a registration message indicating a request for registration of the node information or the like) and transmits the publish message to a root node to notify the root node that the content data is stored (i.e. to publicize that the user node retains the content data to other nodes Nn participating in the system SX1). Thus, the publish message reaches the root node by DHT routing using a content ID as a key in a similar manner as a content location inquiry (search) message. The root node registers index information including a pair of the node information and the content ID included in the received publish message (stores in index cache area). Thus, the user node newly becomes a content retention node retaining the content data.

Here, the index information including a pair of node information and content ID included in the publish message is registered (cached) in a relay node on a transfer route to the root node.

### [1-2. Configuration, Function and the Like of Tree Type Broadcast System SX2]

Next, detailed explanation regarding a tree type broadcast system SX2 will be given.

In the tree type broadcast system SX2, content data are delivered by a streaming method by a node Nn being a broadcast device (broadcast station) (e.g. a node N9 shown in FIG. 2), are sequentially transferred from an upper hierarchy node Nn to a lower hierarchy node Nn (in each node Nn on a transfer route, each packet of content data thus received is buffered and transferred to a lower hierarchy node Nn), and are reproduced in each node Nn.

Here, the node Nn being a broadcast device (broadcast station) can be divided for each content data and broadcast control of content data from the node Nn is carried out according to, for example, broadcast schedule previously set by a broadcast control server (not shown).

Connection status (topology) between nodes Nn in such tree type broadcast system SX2 is managed by a connection management server 10 as a connection management device.

FIG. 6 is a view showing a schematic configuration example of the connection management server 10.

The connection management server 10 includes a control unit 101 as a computer including a CPU having computing function, a RAM for work, a ROM for storing various data and program, and the like, a memory unit 102 including an HD or the like for saving (storing) various data, programs, and the like, and a communication unit 103 for carrying out communication control of information between nodes Nn through the network 8, as shown in FIG. 6. The control unit 101, the memory unit 102, and the communication unit 103 are mutually connected through a bus 104.

Node information indicating each node Nn participating in the tree type broadcast system SX2 (e.g. an IP address and a port number), connection mode information indicating connection mode between each node Nn (topology), and content provision information of each node Nn are stored in the memory unit 102.

Here, the connection mode information includes: (i) hierarchy information indicating a hierarchy where each node Nn is positioned in a hierarchical structure of the tree type broadcast system SX2 (e.g. nodes N10 and N11 shown in FIG. 2 are positioned in the first hierarchy, while nodes N12 to N15 are positioned in the third hierarchy); (ii) lower device information indicating a node Nn connected as a lower hierarchy of each node Nn (e.g. to a node N10 shown in FIG. 2, nodes N12 and N13 are connected as lower hierarchy); (iii) connection permitted number information indicating connection permitted number of nodes Nn which can be connected as lower hierarchy of each node Nn (the number is 2 in the tree type broadcast system SX2 shown in FIG. 2. The number may be 3 or more); and (iv) transfer ability information indicating transfer ability for each node Nn to transfer content data to another node Nn (e.g. processing speed (MHz) of a CPU of a node Nn or an effective bandwidth in the network 8 (e.g. data transfer speed (bps))).

Moreover, the content provision information indicates whether or not a node Nn participating in the tree type broadcast system SX2 is providing content data stored by the own node to another node Nn in the distributed content storing system SX1. In other words, the information indicates whether or not content data is being uploaded by the node Nn as a content retention node. Such content provision information is notified to the connection management server 10 when each node Nn participates in the tree type broadcast system SX2 (e.g. is included in a later-described participation message). Then, such content provision information is updated in a case where a content being provided (provision started) message or a content provision complete message from each node Nn is received by the connection management server 10 or the like. Here, the content being provided (provision started) message is an example of content provision information indicating that content data is being provided and the content provision complete message is an example of content provision complete information indicating completion of provision of content data.

In a configuration of the above-mentioned connection management server 10, the control unit 101 functions as a participation request information receiving means, a connection target determination means, a node information transmission means, a content provision information receiving means, a content provision information update means, a content provision complete information receiving means, a content provision information update means, a connection target change request information receiving means, a connection target change determination means, and a connection target change information transmission means of the present invention when the CPU reads out and executes programs (including a connection management program of the present invention) stored in the memory unit 102 or the like to carry out later-described process. Here, the above-mentioned connection management process program may be, for example, downloaded from a predetermined server on the network 8 or recorded in a recording medium such as a CD-ROM and read out through a drive of the recording medium (same is applied to a later-described node process program).

Specifically, when the control unit 101 receives a participation message (participation request information requesting node information indicating a node Nn to be a connection target of the new participant node) transmitted from a node Nn (hereinafter referred to as a “new participant node”) to newly participate in the tree type broadcast system SX2, the control unit 101 refers to the connection mode information and determines (selects) a node Nn to be a connection target to which the new participant node is to be connected. Here, the participation message is participation request information requesting node information indicating a node Nn to be a connection target of the new participant node. Then, the control unit 101 transmits a connection target introduction message including node information of the node Nn thus determined and hierarchy information of the node Nn thus determined to the new participant node through the communication unit 103 (introduces a connection target). For example, the control unit 101 specifies a node Nn having less than a connection permitted number of nodes Nn connected as lower hierarchy on the basis of the connection mode information. For example, the control unit 101 gives priority to a higher hierarchy node Nn to specify. When there are a plurality of nodes Nn thus specified, the control unit 101 specifies one having, for example, highest transfer ability among the nodes Nn thus specified. Here, as a method for specifying, one node Nn may be randomly selected from the node Nn thus specified. Then, the control unit 101 determines the node Nn thus specified to be a node Nn to be a connection target, includes node information of the node Nn thus determined in a connection target introduction message, and replies to the new participant node.

Moreover, when determining a connection target in such a manner, the control unit 101 refers to the content provision information and determines with priority a node Nn which is not providing content data to another node Nn in the distributed content storing system SX1, in other words, a node Nn which is not uploading, to be a connection target.

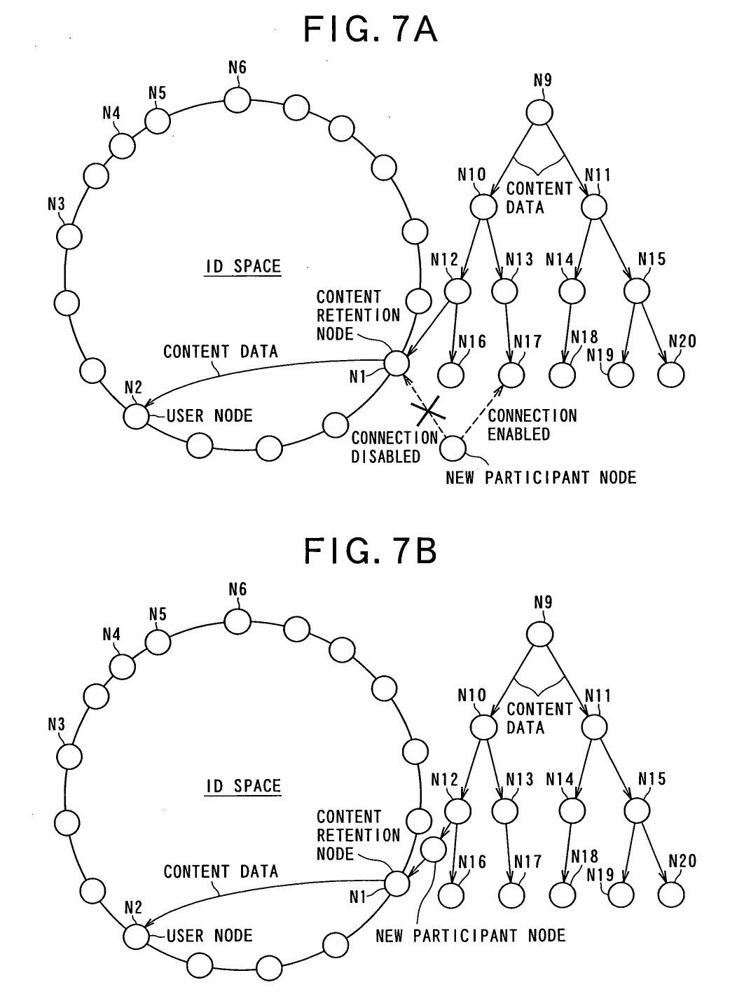

FIG. 7 is a conceptual view showing a connection target of a new participant node. In an example of FIG. 7 (A), a connection target of the new participant node is a node N17 positioned in the lowest hierarchy which is not providing content data and a node N1 providing content data is not determined to be a connection target. On the other hand, in an example of FIG. 7 (B), a connection target of a new participant node is a node N12 positioned in a higher hierarchy of the node N1 which is providing content data and the new participant node is incorporated between the node N1 and the node N12 (connection is changed). In case of the example of FIG. 7 (B), the control unit 101 determines the node N12 positioned in a higher hierarchy of the node N1 providing content data to be a connection target of the new participant node and determines the new participant node to be a new connection target of the node N1. However, when a new participant node is providing content data when participating in the system, process is executed so that the new participant node is not incorporated between nodes Nn as shown in FIG. 7 (B).

Moreover, when the control unit 101 receives a connection target change request message transmitted from a node Nn participating in the tree type broadcast system SX2, the control unit 101 updates content provision information of a node Nn being a transmitter of the connection target change request message (hereinafter referred to as a “connection change request node”), refers to the connection mode information, and determines a node Nn to be a new connection target being connected as a lower hierarchy of the connection change request node by the same method as mentioned above.

Here, the connection target change request message is an example of connection target change request information indicating change request of a connection target of a node Nn being connected as a lower hierarchy of the own node in the tree type broadcast system SX2 to provide content data stored by the own node to another node Nn (a user node) in the distributed content storing system SX1, in other words, to start uploading.

Then, the control unit 101 transmits a connection target change message (connection target change information) including node information, which indicates a node Nn to be a new connection target thus determined, indicating change of a connection target to a node Nn connected as a lower hierarchy of the connection change request node. This is for the purpose of moving a node Nn connected as a lower hierarchy of the connection change request node to a lower hierarchy of another node Nn not providing content data.

At this time, a message for changing a connection target of a connection change request node, that is, a connection target change message which includes node information determining a new connection target of the connection change request node and indicating a node Nn to be a new connection target may be transmitted to the connection change request node.

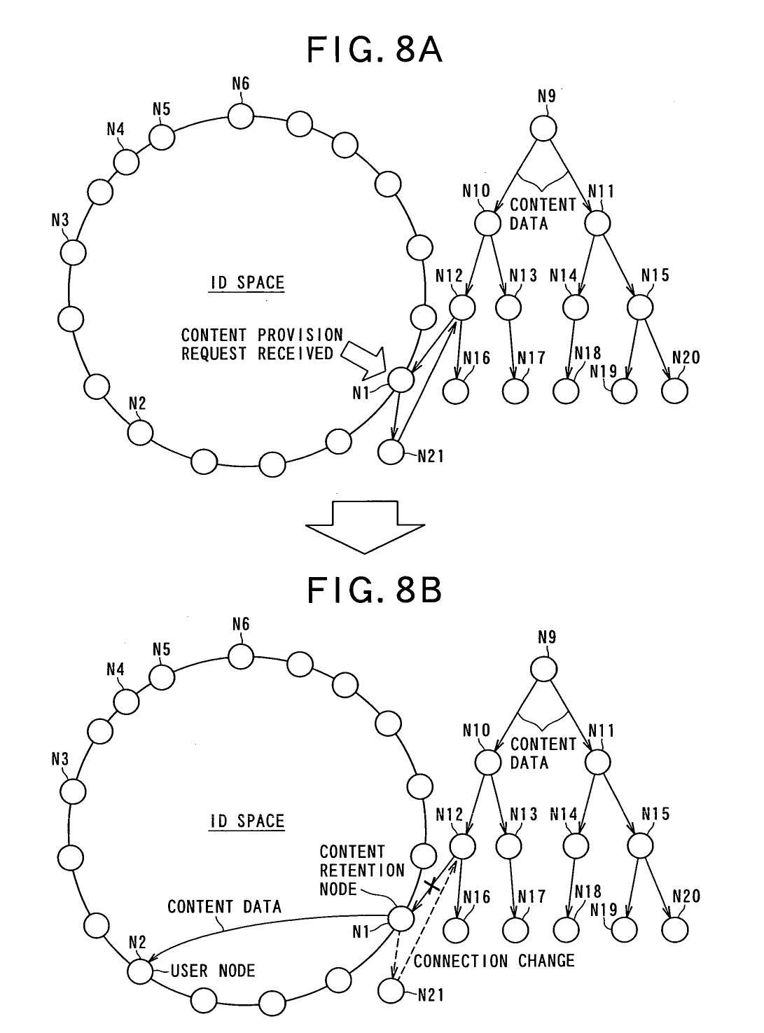

FIG. 8 is a conceptual view showing how connection is changed in a case where a connection target change request is received. In case of an example of FIGS. 8(A) and 8(B), the control unit 101 determines a node N12 of a higher hierarchy, which is connected to the connection change request node N1 as a lower hierarchy, to be a new connection target of a node N21 connected as a lower hierarchy of the connection change request node N1 and, at the same time, determines the node N21 being connected as a lower hierarchy of the connection change request node N1 to be a new connection target of the connection change request node N1.

### [2. Configuration, Function and the Like of Node Nn]

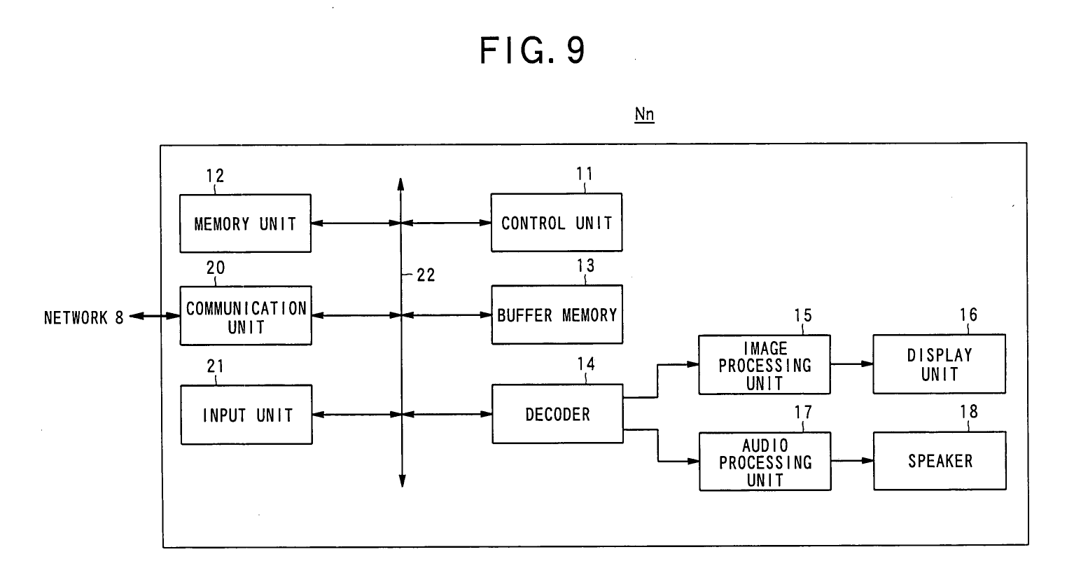

Next, configuration and function of a node Nn will be explained with reference to FIG. 9.

FIG. 9 is a view showing a schematic configuration example of a node Nn.

Each of the node Nn is configured by including, as shown in FIG. 9: a control unit 11 being a computer configured by a CPU having computing function, a RAM for work, and a ROM for storing various data and programs; a memory unit 12 configured by an HD or the like for saving and retaining (storing) various data (e.g. content data, index information, DHT and the like), various types of programs and the like; a buffer memory 13 for temporarily storing content data received or the like; a decoder 14 for decoding (stretching data or decrypt) encoded video data (image information) and audio data (voice information) included in the content data; an image processing unit 15 for providing a predetermined graphic process to the video data thus decoded or the like and outputting the data as video signal; a display unit 16 such as CRT or liquid crystal display for displaying image based on the video signal outputted from the image processing unit 15 or the like; an audio processing unit 17 for converting the decoded audio data in use of digital/analog (D/A) conversion into an analog audio signal, amplifying the converted signal by an amplifier and outputting the same; a speaker 18 for outputting the audio signal outputted from the audio processing unit 17 as acoustic wave; a communication unit 20 for carrying out communication control of information with respect to other nodes Nn and connection management servers 10 via the network 8; and an input unit 21 for receiving instruction signal from a user and providing the instruction signal corresponding to the instruction to the control unit 11 (for example, a keyboard, a mouse, or an operation panel), wherein the control unit 11, the memory unit 12, the buffer memory 13, the decoder 14, the communication unit 20, and the input unit 21 are connected each other via a bus 22. Here, a personal computer, a set top box (STB), or a TV receiver are applicable as the nodes Nn. Moreover, in the memory unit 12, IP address, a port number, and the like of a contact node to be an access target when participating in the distributed content storing system SX1 and IP an address and a port number of the connection management server 10 to be an access target when participating in the tree type broadcast system SX2 are stored.

In such the configuration, when CPU in the control unit 11 reads out and carries out a program stored in the memory unit 12 or the like (including the node processing program according to the present invention), the control unit 11 controls its entirety, carries out a process as any one of the above-mentioned user node, a relay node, a root node, a cache node, and a content retention node by participating in the distributed content storing system SX1.

Moreover, a broadcast schedule list describing a content name, broadcast time, brief summary, and the like of each content data (i.e. broadcast program list) is delivered to each node Nn in advance and the broadcast schedule list is displayed on the display unit 16 by an instruction from a user via the input unit 21. Then, when a user sees the broadcast schedule list and gives a participation instruction into the tree type broadcast system SX2 by operating the input unit 21, the control unit 11 transmits the above-mentioned participation message to the connection management server 10 through the communication unit 20 or the like. At this time, the control unit 11 includes content provision information indicating whether or not the own node is providing content data to another node Nn of the distributed content storing system SX1 in the participation message to be transmitted.

Then, the control unit 11 receives a connection target introduction message from the connection management server 10 through the communication unit 20 and on the basis of node information indicated by the connection target introduction message, the control unit 11 sets up connection with a node Nn to be a higher hierarchy of the own node to carry out transfer request of content data to the node Nn.

Thus, the node Nn participated in the tree type broadcast system SX2 receives each packet of content data transferred (delivered) from a higher hierarchy node Nn to which the own node Nn is connected. Reproduction process is performed through the decoder 14, the image processing unit 15, the display unit 16, the audio processing unit 17, and the speaker 18 while the packet thus received is buffered and in a case where there is a lower hierarchy node Nn, the content data is transferred to the node Nn.

Here, each node Nn transmits a participation message to the connection management server 10 and acquires a connection target introduction message from the connection management server 10 in a case where a node Nn which has withdrawn from the system SX2 due to shut off of the power or a communication trouble participates in the system SX2 again later or in a case where transfer of content data is stopped because a higher hierarchy node Nn withdrew from the system SX2 or stopped transferring, as well as in a case where a node Nn participates in the tree type broadcast system SX2 for the first time.

Moreover, in a case where a node Nn participating in both the distributed content storing system SX1 and the tree type broadcast system SX2 provides content data stored by the own node in response to a request from another node Nn in the distributed content storing system SX1, that is, the above-mentioned content transmission request message, the control unit 11 of the own node transmits a content being provided (provision started) message to the connection management server 10 through the communication unit 20 or the like. Further, in a case where providing content data, the control unit 11 judges whether or not there is a node Nn being connected as a lower hierarchy of the own node. In a case where there is a node Nn connected as a lower hierarchy of the own node, the above-mentioned connection target change request message is transmitted to the connection management server 10 together with the content being provided (provision started) message through the communication unit 20 or the like. Here, instead of the content being provided (provision started) message, connection target change request message may be transmitted to the connection management server 10.

Further, in a case where the provision of the content data is completed, the control unit 11 transmits the above-mentioned content provision complete message to the connection management server 10 through the communication unit 20 or the like.

### [3. Operation of Communication System S]

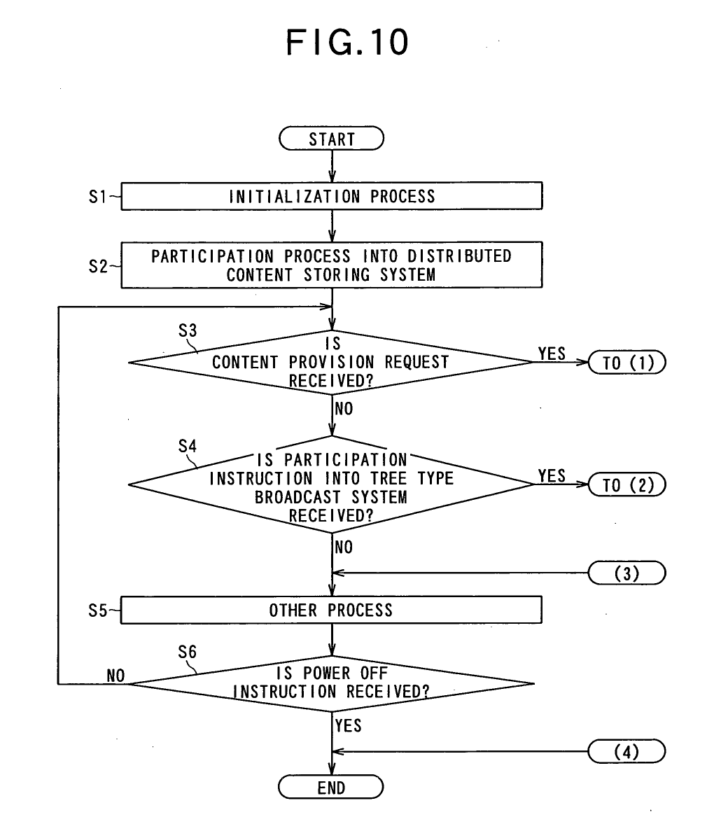

Next, operation of a communication system S according to the present embodiment will be explained with reference to FIGS. 10 to 14.

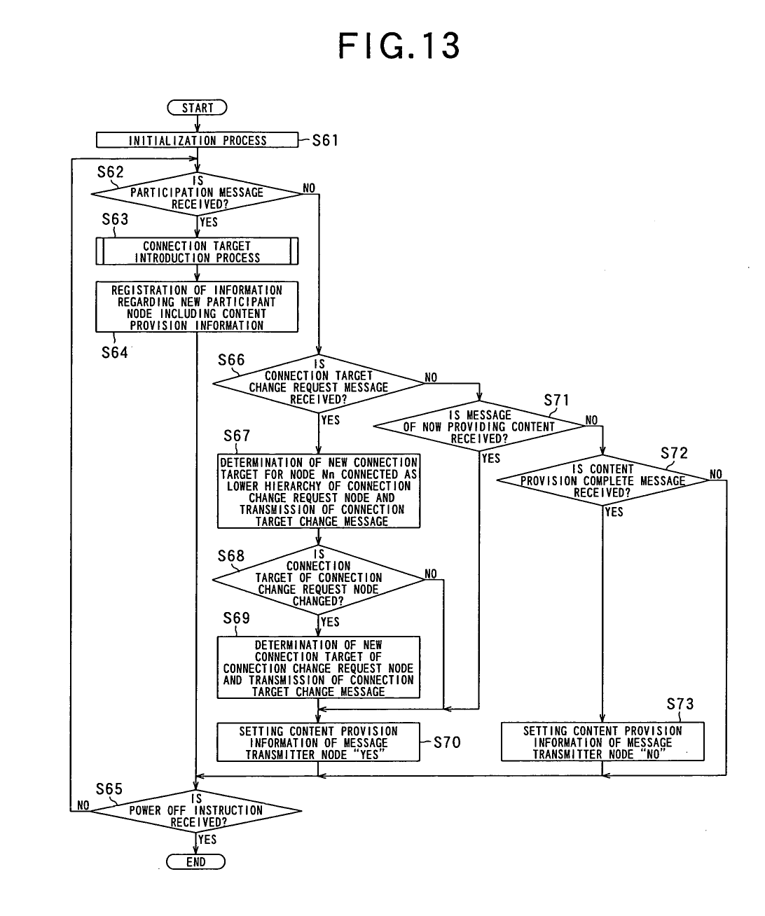

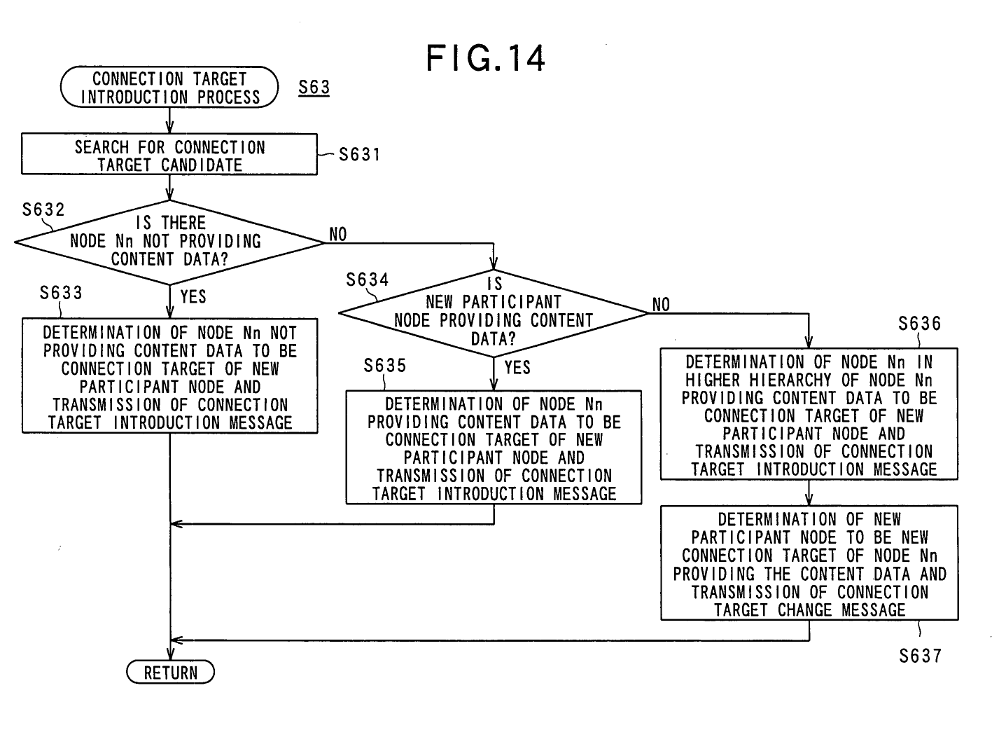

FIGS. 10 to 12 are flowcharts showing process of the control unit 11 of a node Nn and FIGS. 13 and 14 are flowcharts showing process of the control unit 101 of the connection management server 10.

### (Process of Node Nn)

First, process of the control unit 11 of a node Nn will be explained with reference to FIGS. 10 to 12.

Process shown in FIG. 10 is started in a case where, for example, power of an arbitrary node Nn is turned on. After predetermined initialization process is carried out (Step S1), participation process into the distributed content storing system SX1 is carried out (Step S2). In this participation process, the control unit 11 of the node Nn acquires an IP address or the like of a contact node from the memory unit 12 and on the basis thereof, is connected to the contact node through the network 8 to transmit a participation message indicating participation request. Thus, a routing table using a DHT is transmitted to the node Nn from another node Nn participating in the system SX1. On the basis of the routing table thus received, the node Nn generates a routing table using a DHT and participation into the distributed content storing system SX1 is completed. Because generation method of a routing table using a DHT is not directly related to the present invention, detailed explanation thereof is omitted.

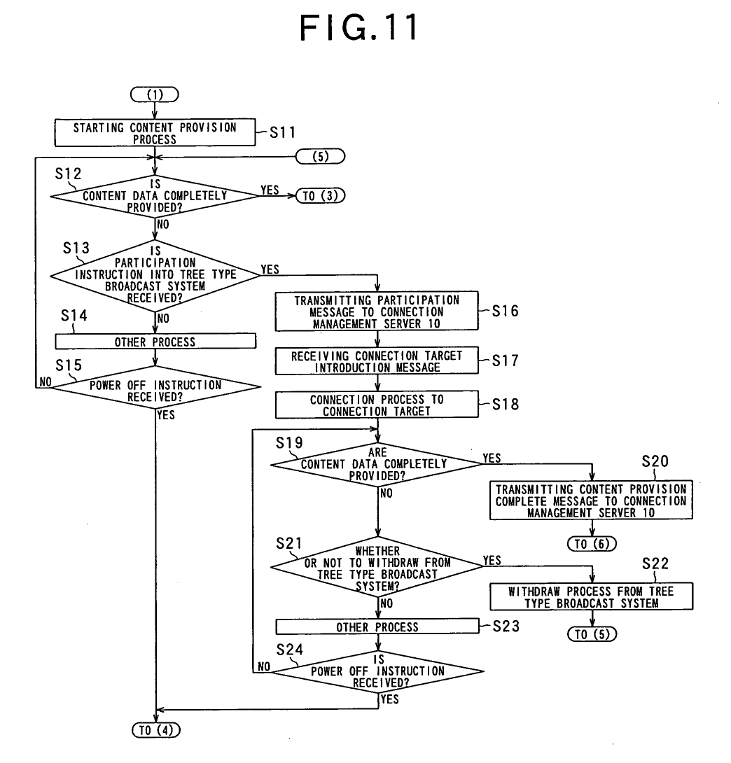

Next, the control unit 11 judges whether or not there is a content provision request from another node Nn (Step S3). In a case where there is a content provision request, in other words, an upload request of content data from a user node in the distributed content storing system SX1, i.e. in a case where the above-mentioned content transmission request message is received (Step S3: YES), the process proceeds to Step S11 (1) shown in FIG. 11. In a case where the content provision request is not received (Step S3: NO), the process proceeds to Step S4.

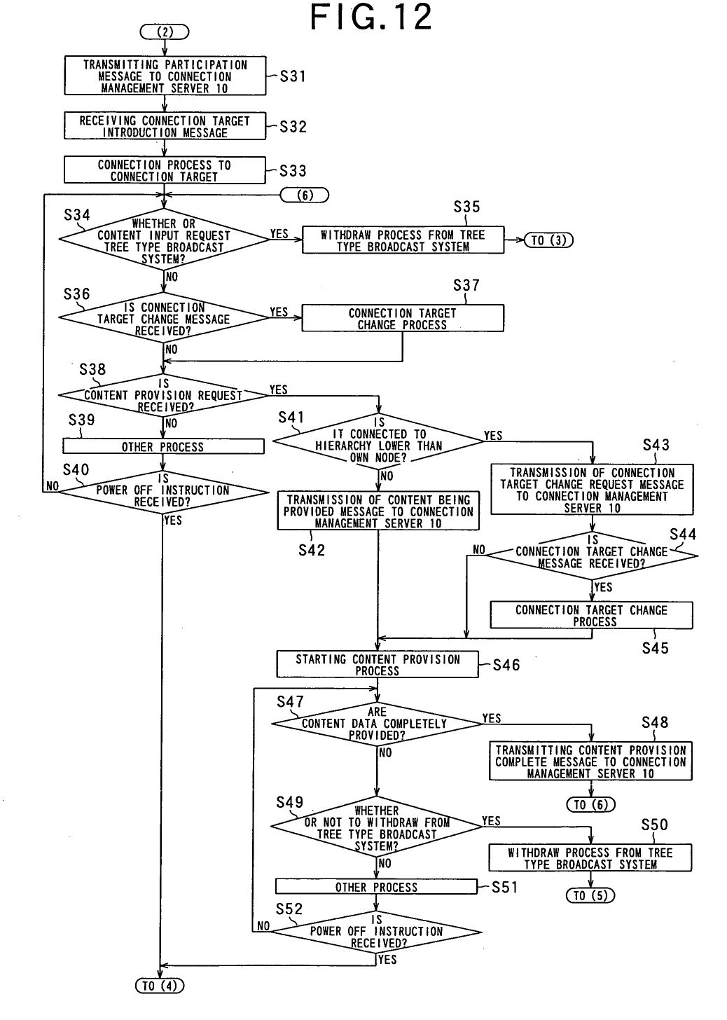

In Step S4, the control unit 11 judges whether or not there is a participation instruction into the tree type broadcast system SX2. In a case where there is the participation instruction, for example, participation instruction from a user through the input unit 21 (Step S4: YES), the process proceeds to Step S31 (2) shown in FIG. 12. In a case where there is no participation instruction into the tree type broadcast system SX2 (Step S4: NO), the process proceeds to Step S5.

In other process in Step S5, for example, transmission/receiving process of the above-mentioned various messages or process in response to an instruction from the user through the input unit 21 such as reproduction process of content data or the like is carried out. However, such process is not directly related to the present invention and therefore detailed explanation thereof is omitted.

In Step S6, the control unit 11 judges whether or not a power off instruction is received. In a case where the power off instruction is received, for example in a case where the power off instruction from the user through the input unit 21 (Step S6: YES), the process is finished. On the other hand, in a case where the power off instruction is not received (Step S6: NO), the process returns to Step S3 and the process is continued.

In the above-mentioned Step S3, if there is the content provision request (Step S3: YES) and the process proceeds to Step S11 (1) shown in FIG. 11, the control unit 11 reads out content data which is a target of the provision request from the memory unit 102 and starts content providing process for providing the content data to a node through the communication unit 103.

Next, the control unit 11 judges whether or not provision of the content data is finished (Step S12). In a case where finished (Step S12: YES), the process proceeds to Step S5 (3) shown in FIG. 10. In a case where not finished (Step S12: NO), the control unit 11 judges whether or not there is participation into tree type broadcast system SX2, that is, a participation instruction into the tree type broadcast system SX2 which is providing content data (Step S13).

Then, in a case where there is not a participation instruction into the tree type broadcast system SX2 (Step S13: NO), the process proceeds to Step S14. In a case where there is the participation instruction (Step S13: YES), the process proceeds to Step S16.

Here, in Step S14, provision process of content data is carried out in addition to the same process as that in the above-mentioned Step S5 and Step S15 is the same as the above-mentioned Step S6. In Step S15, in a case where a power off instruction is received (Step S15: YES), the process is finished. In a case where the power off instruction is not received (Step S15: NO), the process returns to Step S12 and the process is continued.

In Step S16, the control unit 11 acquires the IP address or the like of the connection management server 10 from the memory unit 12 and on the basis thereof, is connected to the connection management server 10 through the communication unit 20 and the network 8. Then, the control unit 11 includes information indicating that content data is being provided in a participation message indicating participation request into the tree type broadcast system SX2 and transmits the participation message to the connection management server 10.

Subsequently, the control unit 11 receives a connection target introduction message transmitted from the connection management server 10 in response to the participation message (Step S17) and carries out connection process to a connection target indicated in the connection target introduction message (Step S18). In the connection process, the control unit 11 is connected to the node Nn on the basis of node information of the node Nn of a higher hierarchy to be a connection target indicated by the connection target introduction message and carries out transfer request of content data. Thus, the control unit 11 receives content data transferred from the node Nn and starts reproduction process.

Next, the control unit 11 judges whether or not provision of content data is finished (Step S19). In a case where the provision of content data is finished (Step S19: YES), the process proceeds to Step S20. In a case where the provision of content data is not finished (Step S19: NO), the process proceeds to Step S21.

In Step S20, the control unit 11 transmits the above-mentioned content provision complete message to the connection management server 10 through the communication unit 20 and the network 8. Then, the process proceeds to Step S34 (6) shown in FIG. 12.

In Step S21, the control unit 11 judges whether or not the own node withdraws from the tree type broadcast system SX2. In a case where the own node withdraws, for example, in a case where there is a withdrawal instruction from a user through the input unit 21 (Step S21: YES), the process proceeds to Step S22. In a case where the own node does not withdraw (Step S21: NO), the process proceeds to Step S23.

In Step S22, the control unit 11 carries out withdrawal process from the tree type broadcast system SX2 and the process returns to Step S12 (5). In such a withdrawal process, for example, information indicating that the own node withdraws from the tree type broadcast system SX2 is transmitted to a node Nn of a higher hierarchy to which the own node is being connected and to the connection management server 10.

Here, in Step S23, receiving and reproduction process of content data transferred from a node Nn of a higher hierarchy or the like is carried out in addition to the same process as in the above-mentioned Step S14 and Step S24 is the same as the above-mentioned Step S6. In a case where a power off instruction is received in Step S24 (Step S24: YES), the process is finished. In a case where a power off instruction is not received (Step S24: NO), the process returns to Step S19 and the process is continued.

In the above-mentioned Step S4, with a participation instruction into the tree type broadcast system SX2, the process proceeds to Step S31 (2) shown in FIG. 12. Then, the control unit 11 is connected to the connection management server 10, includes information indicating that the own node is not providing content data in a participation message indicating participation request into the tree type broadcast system SX2, and transmits the participation message to the connection management server 10.

Next, the control unit 11 receives a connection target introduction message transmitted from the connection management server 10 in response to the participation message (Step S32) and similarly to the above-mentioned Step S18, carries out connection process to a connection target shown in the connection target introduction message (Step S33).

Subsequently, the control unit 11 judges whether or not the own node withdraws from the tree type broadcast system SX2 (Step S34). In a case where the own node withdraws (Step S34: YES), withdrawal process from the tree type broadcast system SX2 is carried out (Step S35) and the process proceeds to Step S5 (3) shown in FIG. 10. In a case where the own node does not withdraw (Step S34: NO), the process proceeds to Step S36.

In Step S36, the control unit 11 judges whether or not a connection target change message from the connection management server 10 is received. In a case where the message is not received (Step S36: NO), the process proceeds to Step S38. In a case where the message is received (Step S36: YES), connection target change process is carried out (Step S37) and the process proceeds to Step S38. In such a connection target change process, the control unit 11 is connected to a node Nn of a higher hierarchy to be a connection target indicated by the connection target change message on the basis of node information of the node Nn and carries out transfer request of content data. Then, the control unit 11 cuts out connection with a node Nn of a former higher hierarchy (e.g. status shown in FIG. 8).

In Step S38, the control unit 11 judges whether or not a content provision request is received from another node Nn (similarly to Step S3). In a case where a content provision request from the user node in the distributed content storing system SX1 is received, that is, in a case where the above-mentioned content transmission request message is received (Step S38: YES), the process proceeds to Step S41. In a case where the content provision request is not received (Step S38: NO), the process proceeds to Step S39.

Here, receiving and reproduction process of content data transferred from a node Nn of a higher hierarchy or the like is carried out in Step S39 in addition to the same process as in the above-mentioned Step S5 and Step S40 is the same as the above-mentioned Step S6. In a case where the power off instruction is received in Step S40 (Step S40: YES), the process is finished. Meanwhile, when the power off instruction is not received (Step S40: NO), the process returns to Step S34 and the process is continued.

In Step S41, the control unit 11 judges whether or not there is a node Nn connected as a lower hierarchy of the own node. In a case where there is not a lower hierarchy node, that is, the own node is positioned in the lowest hierarchy (Step S41: NO), the process proceeds to Step S42. In a case where there is a lower hierarchy node (Step S41: YES), the process proceeds to Step S43.

In Step S42, the control unit 11 transmits the above-mentioned content being provided message to the connection management server 10 through the communication unit 20 and the network 8 and the process proceeds to Step S46.

In Step S43, the control unit 11 includes information indicating that content data is being provided in the above-mentioned connection target change request message to cause a connection target of a node Nn connected as a lower hierarchy of the own node to change the connection target and transmits the message to the connection management server 10 through the communication unit 20 and the network 8.

In Step S44, the control unit 11 judges whether or not a connection target change message is received from the connection management server 10. In a case where the message is not received (Step S44: NO), the process proceeds to Step S46. In a case where the message is received, for example, in a case where connection mode is changed due to the connection target change request message transmitted by the own node as shown in FIG. 8 (Step S44: YES), connection target change process is carried out (Step S45). In such a connection target change process, the control unit 11 is connected to the node Nn on the basis of node information of a node Nn of a higher hierarchy to be a new connection target indicated by the connection target change message and carries out transfer request of content data. Then, the control unit 11 cuts out connection with a node Nn of a former higher hierarchy.

In Step S46, the control unit 11 reads out content data which is a target of the provision request from the memory unit 102 and starts content providing process to provide the content data to a user node through the communication unit 103 or the like.

Subsequently, the control unit 11 judges whether or not provision of the content data is finished (Step S47). In a case where the provision is finished (Step S47: YES), the control unit 11 transmits the above-mentioned content provision complete message to the connection management server 10 through the communication unit 20 and the network 8 (Step S48) and the process returns to Step S34 (6). In a case where the provision is not finished (Step S47: NO), the process proceeds to Step S49.

In Step S49, the control unit 11 judges whether or not the own node withdraws from the tree type broadcast system SX2. In a case where the own node withdraws (Step S49: YES), the process proceeds to Step S50. In a case where the own node does not withdraw (Step S49: NO), the process proceeds to Step S51.

In Step S50, the control unit 11 carries out withdrawal process from the tree type broadcast system SX2, similarly to Step S22, and the process proceeds to Step S12 (5).

Here, process in Step S51 is the same as that of the above-mentioned Step S23 and the process in Step S52 is the same as that of the above-mentioned Step S6. In a case where there is a power off instruction in Step S52 (Step S52: YES), the process is finished. In a case where there is not a power off instruction (Step S52: NO), the process returns to Step S47 and the process is continued.

### (Process of Connection Management Server 10)

Next, process of the control unit 101 of the connection management server 10 will be explained with reference to FIGS. 13 and 14.

Process shown in FIG. 13 is started in a case where, for example, power of the connection management server 10 is turned on and a predetermined initialization process is carries out (Step S61).

Then, the control unit 101 judges whether or not a participation message from a node Nn is received (Step S62). In a case where a message is received (Step S62: YES), the process proceeds to Step S63. In a case where a message is not received (Step S62: NO), the process proceeds to Step S66.

In Step S63, the control unit 101 carries out connection target introduction process. As shown in FIG. 14, in the connection target introduction process, the control unit 101 refers to content provision information and connection mode information of all the nodes Nn and searches for a node Nn which is not providing content data and currently has less than connection permitted number of nodes Nn connected as lower hierarchy as a connection target candidate (Step S631).

Then, the control unit 11 judges whether or not there is a node Nn which is not providing content data (Step S632). In a case where there is a node Nn providing content data (Step S632: YES), the process proceeds to Step S633. In a case where there is not a node Nn providing content data (Step S632: NO), the process proceeds to Step S634.

In Step S633, the control unit 101 determines a node Nn which is not providing content data to be a connection target of a new participant node which transmitted the participation message. However, in a case where there are a plurality of nodes Nn which are not providing content data, the control unit 101 determines, for example, a node Nn having the highest transfer ability as a connection target. Then, the control unit 101 replies a connection target introduction message including node information of the node Nn to be the connection target to a new participant node and returns to process shown in FIG. 13.

Meanwhile, in Step S634, the control unit 101 judges whether or not the new participant node is providing content data. In a case where the new participant node is providing content data (Step S634: YES), the process proceeds to Step S635. In a case where the new participant node is not providing content data (Step S634: NO), the process proceeds to Step S636.

In Step S635, the control unit 101 determines a node Nn which is providing content data to be a connection target of the new participant node. That is, because there is no node Nn not providing content data, the control unit 101 has no choice but to determine a node Nn currently providing content data and having less than connection permitted number of nodes Nn as lower hierarchy to be a connection target. Then, the control unit 101 replies a connection target introduction message including node information or the like of node Nn thus determined to the new participant node and returns to process shown in FIG. 13.

Meanwhile, in Step S636, the control unit 101 determines a node Nn of a higher hierarchy node Nn to which a node Nn providing content data is connected to be a connection target of the new participant node and replies a connection target introduction message including node information or the like to the new participant node. Subsequently, the control unit 101 determines the new participant node to be a new connection target of the node Nn providing content data (e.g. status shown in FIG. 7 (B)), replies a connection target change message including the node information to the node Nn providing content data (Step S637), and returns to process shown in FIG. 13.

In Step S64 shown in FIG. 13, the control unit 101 registers, that is, set in a predetermined area of the memory unit 102, node information connection mode information, and content provision information of the new participant node, and the process proceeds to Step S65.

In Step S66, the control unit 101 judges whether or not a connection change request message from a node Nn is received. In a case where a message is received (Step S66: YES), the process proceeds to Step S67. In a case where a message is not received (Step S66: NO), the process proceeds to Step S71.

In Step S67, the control unit 101 determines a node Nn to be a new connection target of a node Nn to be connected to a lower hierarchy of a connection change request node which transmitted the connection target change request message and transmits a connection target change message including node information or the like to the node Nn to be connected to the lower hierarchy.

Next, the control unit 101 judges whether or not a connection target of the connection change request node is changed by, for example, previously set information (Step S68). In a case where the connection target is changed (Step S68: YES), the process proceeds to Step S69. In a case where the connection target is not changed (Step S68: NO), the process proceeds to Step S70.

In Step S69, the control unit 101 determines a node Nn to be a new connection target of the connection change request node and replies a connection target change message including node information or the like to the connection change request node (e.g. status shown in FIG. 8). Then, the process proceeds to Step S70.

In Step S70, the control unit 101 sets content provision information of the connection change request node to “Yes” and the process proceeds to Step S65.

In Step S71, the control unit 101 judges whether or not a content being provided message from a node Nn is received. In a case where the message is received (Step S71: YES), the control unit 101 sets content provision information of the node Nn to be “Yes” (Step S70) and the process proceeds to Step S65. In a case where the message is not received (Step S71: NO), the process proceeds to Step S72.

In Step S72, the control unit 101 judges whether or not a content provision complete message from a node Nn is received. In a case where the message is received (Step S72: YES), the control unit 101 sets content provision information of the node Nn to be “No” (Step S73) and the process proceeds to Step S65. In a case where the message is not received (Step S72: NO), the process proceeds to Step S65.

In Step S65, the control unit 101 judges whether or not a power off instruction is received. In a case where the instruction is received (Step S65: YES), the process is finished. In a case where the instruction is not received (Step S65: NO), the process returns to Step S62 and the process is continued.

As explained above, according to the present embodiment, the connection management server 10 stores and manages content provision information indicating whether or not a node Nn participating in the tree type broadcast system SX2 is providing content data in the distributed content storing system SX1, refers to the content provision information when a participation message from a new participant node is received, determines a node Nn which is not providing content data to another node Nn in the distributed content storing system SX1 with priority as a connection target of the new participant node, and transmits a connection target introduction message including node information indicating the node Nn to be a connection target thus determined to introduce a connection target. Therefore, even in a case where a node Nn participates in both the distributed content storing system SX1 and the tree type broadcast system SX2, increase of process load of the node Nn and load of a line to which the node Nn is connected is suppressed and content data can be stably provided.

Moreover, since the above-mentioned content provision information is included in a participation message, the content provision information can be notified to the connection management server 10 when a node Nn participates in the tree type broadcast system SX2 and the connection management server 10 can efficiently acquire content provision information of each node Nn participating in the tree type broadcast system SX2.

Further, each node Nn participating in the tree type broadcast system SX2 transmits content being provided (provision started) message to the connection management server 10 in a case where content data is provided to another node Nn in the distributed content storing system SX1 and a content provision complete message is transmitted to the connection management server 10 in a case where provision of content data is finished. Therefore, the connection management server 10 can always maintain content provision information of each node Nn at the latest condition.

Further, each node Nn participating in the tree type broadcast system SX2 judges whether or not there is a node Nn connected as a lower hierarchy of the own node in a case of providing content data. When there is a node Nn connected as a lower hierarchy of the own node, the own node transmits a connection target change request message to the connection management server 10. In response thereto, the connection management server 10 determines a node Nn to be a new connection target of the node Nn connected as a lower hierarchy of the own node Nn and transmits a connection target change message including node information of a node Nn to be a new connection target thus determined which indicates change of a connection target to the node Nn connected as a lower hierarchy to change a connection target. Therefore, it is possible to suppress process load of a node Nn which provides the content data and load of a line to which the node Nn is connected and to stably provide content data. At this time, when a node Nn connected as a higher hierarchy of the connection change request node is set to be a new connection target of the node Nn connected as a lower hierarchy of the connection change request node and a node Nn connected as a lower hierarchy of the connection change request node is set to be a new connection target of the connection change request node, connection change is carried out more rapidly and it becomes possible to respond to provision request of content data from another node Nn in the distributed content storing system SX1.

Here, the explanation was given on a premise that the distributed content storing system SX1 of the above-mentioned embodiment is configured by algorithm using DHT. However, the present invention is not limited thereto.

The present invention is not confined to the configuration listed in the foregoing embodiments, but it is easily understood that the person skilled in the art can modify such configurations into various other modes, within the scope of the present invention described in the claims.

What is claimed is:

1. A connection management device for managing connection mode between node devices in a tree type broadcast system formed by participation of all or a part of a plurality of node devices included in a distributed content storing system where a plurality of content data are distributed and stored in the plurality of node devices and each of the plurality of node devices provides content data stored in the own node through a network in response to a request from the other node devices, the tree type broadcast system being connected in a tree-like shape through a communication means while having a broadcasting device at its top and forming a plurality of hierarchies of the node devices through the communication means, to thereby sequentially transfer the content data broadcasted by the broadcasting device from the node devices on upper hierarchies to the node devices on lower hierarchies, the connection management device comprising:
a memorizing means for memorizing content provision existence information indicative of whether or not the node device, participating in the tree type broadcast system, is providing content data, stored by the own node, to another node device in the distributed content storing system;
a participation request information receiving means for receiving participation request information transmitted from the node device, newly participating in the tree type broadcast system, which requests node information indicative of the node device to be a connection target, to which the node device is to be connected;
a connection target determining means for determining the node device to be the connection target for the node device transmitting the participation request information, the connection target determining means determining by priority the node device which is not in a state of providing the content data to the other node devices in reference of the content provision existence information; and
anode information transmission means for transmitting node information indicative of the node device to be the connection target thus determined to the node device transmitting the participation request information.

2. The connection management device according to claim 1,
wherein the participation request information includes the content provision existence information indicative of whether or not the node device which transmits the participation request information is now providing content data stored by the own node to the node devices in the distributed content storing system.

3. The connection management device according to claim 1, further comprising:
a content provision available information receiving means for receiving content provision available information which is transmitted from the node device, now participating in the tree type broadcast system, and for indicating that content data stored by the own node is now provided to the other node device in the distributed content storing system; and
a content provision existence information update means for updating the content provision existence information thus memorized on the basis of the content provision existence information thus received.

4. The connection management device according to claim 1, further comprising:
a content provision end information receiving means for receiving content provision end information which is transmitted from the node device participating in the tree type broadcast system and indicating that the provision of content data stored by the own node to the other node device in the distributed content storing system ends; and
a content provision existence information update means for updating content provision existence information memorized on the basis of the content provision end information thus received.

5. The connection management device according to claim 1, further comprising:
a connection target change request information receiving means for receiving connection target change request information indicative of a change request of the connection target for the node device, which is connected at a lower hierarchy of the own node in the tree-type broadcasting system so as to provide content data stored by the own node to the other node device in the distributed content storing system, the connection target change request information being transmitted from the node device now participating in the tree-type broadcasting system;
a connection target change determining means for determining the node device to be a new connection target for the node device connected as the lower hierarchy of the node device, transmitting the connection target change request information in response to the connection target change request information thus received; and
a connection target change information transmission means for transmitting connection target change information, which includes node information indicative of the node device to be the new connection target thus determined and indicates change of the connection target, to the node device connected as the lower hierarchy.

6. The connection management device according to claim 5,
wherein the connection target change determining means determines the node device to be a new connection target of the node device transmitting the connection target change request information in response to the connection target change request information thus received, and
the connection target change information transmission means transmits the node information indicative of the node device thus determined to be the new connection target to the node device, transmitting the connection target change request information.

7. The connection management device according to claim 6,
wherein the connection target change determining means determines the node device at a higher hierarchy, to which the node device transmitted the connection target change request information is connected, as the new connection target of the node device connected as the lower hierarchy of the node device, which transmits the connection target change request information, and determines the node device connected as the lower hierarchy of the node device to be the new connection target of the node device, which transmits the connection target change request information.

8. The node device newly participating in the tree type broadcast system according to claim 2, further comprising:
a participation request information transmission means for transmitting the participation request information including the content provision existence information to the connection management device; and
a node information receiving means for receiving node information indicative of the node device to be a connection target, the node information being transmitted from the connection management device in response to the participation request information.

9. The node device participating in the tree type broadcast system according to claim 5, further comprising:
a lower hierarchy existence judgment means for judging whether or not there is the node device connected as the lower hierarchy of the own node when the own node provides content data stored by the own node in response to a request from the other node device in the distributed content storing system; and
a connection target change request information transmission means for transmitting the connection target change request information to the connection management device in a case where there is the node device connected as the lower hierarchy of the own node.

10. A connection management process program embodied in a computer-readable medium and representing a sequence of instructions, which when executed by a computer included in the node device, the instructions cause the computer to function as:
a connection management device according to claim 1.

11. A node process program embodied in a computer-readable medium and representing a sequence of instructions, which when executed by a computer included in the node device, the instructions cause the computer to function as:
the node device according to claim 8.

12. A tree type broadcast system formed by participation of all or a part of a plurality of node devices included in a distributed content storing system where a plurality of content data are distributed and stored in the plurality of node devices and each of the plurality of node devices provides content data stored by the own node through a network in response to a request from the other node device, the tree type broadcast system being connected in a tree-like shape through a communication means while having a broadcasting device at its top and forming a plurality of hierarchies of the node devices through the communication means, to thereby sequentially transfer the content data broadcasted by the broadcasting device from the node devices on upper hierarchies to the node devices on lower hierarchies,
wherein the node device comprising:
a participation request information transmission means for transmitting participation request information of requesting node information indicative of the node device, to which the own node is to be connected, to the connection management device for managing connection mode among the node devices in the tree type broadcast system, and
the connection management device, comprising:
a memorizing means for memorizing content provision existence information indicative of whether or not the node device participating in the tree type broadcast system is now providing content data stored by the own node to the other node device in the distributed content storing system;
a participation request information receiving means for receiving the participation request information, transmitted from the node device;
a connection target determining means for determining the node device to be the connection target of the node device transmitting the participation request information, the connection target determining means refers to the content provision information to thereby determine with priority the node device which is not now providing the content data to the other node device in the distributed content storing system to be the connection target; and
a node information transmission means for transmitting node information indicative of the node device to be the connection target thus determined to the node device, transmitting the participation request information.

13. A connection target determining method in a tree type broadcast system formed by participation of all or a part of a plurality of node devices included in a distributed content storing system where a plurality of content data are distributed and stored in the plurality of node devices and each of the plurality of node devices provides content data stored by the own node through a network in response to a request from the other node device, the tree type broadcast system being connected in a tree-like shape through a communication means while having a broadcasting device at its top and forming a plurality of hierarchies of the node devices through the communication means, to thereby sequentially transfer the content data broadcasted by the broadcasting device from the node devices on upper hierarchies to the node devices on lower hierarchies,
wherein functions of the node device comprising steps of:
transmitting participation request information of requesting node information indicative of the node device, to which the own node is to be connected, to the connection management device for managing connection mode among the node devices in the tree type broadcast system, and
functions of the connection management device comprising steps of:
memorizing content provision existence information indicative of whether or not the node device participating in the tree type broadcast system is now providing content data stored by the own node to the other node device in the distributed content storing system;
receiving the participation request information, transmitted from the node device;
determining the node device to be the connection target of the node device transmitting the participation request information, the connection target determining means refers to the content provision information to thereby determine with priority the node device which is not now providing the content data to the other node device in the distributed content storing system to be the connection target; and
transmitting node information indicative of the node device to be the connection target thus determined to the node device, transmitting the participation request information.
